(19) United States
(12) Patent Application Publication
(10) Pub. No.: US 2016/0253734 A1
(43) Pub. Date: Sep. 1, 2016

(54) SYSTEM, METHOD, AND NON-TRANSITORY COMPUTER-READABLE STORAGE MEDIA FOR ENHANCING ONLINE PRODUCT SEARCH THROUGH RETAIL BUSINESS PROCESS AWARENESS

(71) Applicant: Wal-Mart Stores, Inc., Bentonville, AR (US)

(72) Inventor: Dintyala Venkata Subrahmanya Ravikant, Fremont, CA (US)

(21) Appl. No.: 14/634,649

(22) Filed: Feb. 27, 2015

(51) Int. Cl. G06Q 30/06

(52) U.S. Cl. CPC G06Q 30/0629

(57) ABSTRACT

A system and method includes a computer system having a server configured to receive a product search query, the server being configured to receive a product search query, receive data on products, compute product insights on the products, evaluate the product insights, marking those product insights that need validation, output the product insights that need validation, rank the products trading off relevance with testing promising products, and output a mix of relevant and promising products as search results to a user device of a user.

### BACKGROUND OF THE INVENTION

1. Field of the Invention

The present invention relates generally to enhancing product searches on websites, and more particularly, to systems, methods, and computer-readable storage medias that enhance online product searches through retail business process awareness.

2. Description of the Related Art

Many consumers desire to order items or products remotely, e.g., on-line, through the Internet, using a specially designed application or app on a personal computer or mobile device, such as a tablet or cell phone. The consumer enters the name of the product in a search query on the app and a search engine of the retailer presents search results of selected products to the personal computer or mobile device of the consumer.

In addition, known search engines may sort the selected products based on product ranking. Search engines take relevance into account. Known search engines are also known for doing well for search queries and products where they have sufficient user interaction/click logs, however, they face difficulties for products for which they have no history. Search engine's notion of relevance may diverge significantly from consumer notion of relevance and the sorted lists do not display products that are relevant to the consumers needs.

Natural language search is the glue connecting retailers and consumers in e-commerce. It provides consumers a way to find (retrieve/seek/discover) products with minimum effort/time and retailers a lens into consumer priorities.

Demand forecasting product inventory and product distribution planning are integral components of supply chain optimization and economies of scale in retailing. They are key enablers of everyday low cost/operational efficiency. Large pre-orders and pre-purchases also improve manufacturers' cash on hand/liquidity and reduce costs of production.

However, product searches on websites suffer from the disadvantage that some products that are promising may not be presented in the search results to the consumer. This may be due to the language inputted into the search query or because the promising products have no user interaction data are from new brands/in new categories/are completely novel and are not ranked high enough to be presented in the search results to the consumer.

It is, therefore, desirable to provide a new system and method which enhances online product searches in an e-commerce marketplace for a large retailer. It is also desirable to provide a new system and method that automates ways to augment online learning within an online product search with business process information. It is further desirable to provide a new system and method that can acquire new knowledge about a search query or product and exploit them to improve product ranking. Thus, there is a need in the art to provide a system that enhances online product searches through retail business process awareness accessed by the consumer and method of using same that meets at least one of these desires.

### SUMMARY OF THE INVENTION

In different embodiments of the present invention, systems, methods, and computer-readable storage medias enhance online product searches through retail business process awareness accessed by a consumer via a website/app.

In one embodiment, a system includes a computer system having a server configured to receive a product search query. The server is configured to receive data on products, to compute product insights on the products, to evaluate the product insights, to mark those product insights that need validation, to output the product insights that need validation, to rank the products trading off relevance with testing promising products, and to output a mix of relevant and promising products as search results to a user device of a user.

In addition, the system also includes a recalibration module (validation) that infers invalid product hints based on (lack of) user interaction on products and provides feedback to the retailer.

In another embodiment, a method includes the steps of receiving a product search query, receiving data on products, computing product insights on the products, evaluating the product insights, marking those product insights that need validation, outputting the product insights that need validation, ranking the products trading off relevance with testing promising products, and outputting a mix of relevant and promising products as search results to a user device of a user.

In addition, the method also includes the step of vetting out invalid product insights based on user interactions and tracing the invalid product insights back to business actions, thereby providing feedback for improving a business cycle.

In yet another embodiment, one or more non-transitory computer-readable storage media, having computer-executable instructions embodied thereon are provided. When executed by at least one processor, the computer-executable instructions cause the processor to receive a product search query, receive data on products, compute product insights on the products, evaluate the product insights, mark those product insights that need validation, output the product insights that need validation, rank the products trading off relevance with testing promising products, and output a mix of relevant and promising products as search results to a user device of a user.

One advantage of the present invention is that a system, method, and non-transitory computer-readable storage media is provided that augments online learning within an online product search with business process information, e.g., inventory planning, for products heavily marketed, but not doing well. Another advantage of the present invention is that the system, method, and non-transitory computer-readable storage media incorporates online reinforcement learning that provides a framework to explore/exploit where one can probe and acquire new knowledge about product utilities (query, product) and exploit them to improve product ranking. Yet another advantage of the present invention is that the system, method, and non-transitory computer-readable storage media allows testing, validating and reinforcing “right” products and improve overall effectiveness of a search for consumers and retailers.

Other features and advantages of the present invention will be readily appreciated, as the same becomes better understood, after reading the subsequent description taken in conjunction with the accompanying drawings.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagrammatic view of a system, according to one embodiment of the present invention, illustrated in operational relationship with at least one user device of a consumer.

FIG. 2 is a diagrammatic view of a portion of the system of FIG. 1.

FIG. 3 is a diagrammatic view of one embodiment of the system and user device of FIG. 1.

FIG. 4 is a diagrammatic view of one portion of the system and user device of FIG. 3.

FIG. 5 is a diagrammatic view of another portion of the system and user device of FIG. 3.

FIG. 6 is a diagrammatic view of yet another portion of the system and user device of FIG. 3.

FIG. 7 is a flowchart of a method that may be used with the system shown in FIGS. 1 through 6, according to an embodiment of the present invention.

FIG. 8 is an illustration of an exemplary screenshot from the system of FIGS. 1 through 6, according to an embodiment of the present invention.

FIG. 9 is an illustration of an exemplary screenshot from the system of FIGS. 1 through 6, according to an embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION OF THE PREFERRED EMBODIMENT(S)

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should be appreciated that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

The disclosure particularly describes how an online product search for a retailer is enhanced through retail business process awareness to allow promising products to be presented to a consumer for a predefined user activity such as, for example, purchasing a product via a website/app. Particularly, the present disclosure describes how a system provides a website/app to a consumer to allow the consumer to conduct an online product search to purchase and/or order products via the website/app, to augment online learning within the product search with hints from business process information, and to present promising products within the website/app to the consumer that facilitate inducing the consumer to purchase a product via the website/app. In addition, the disclosure describes how to vet out inaccurate product insights, trace them back to business actions, and alert retailers/planners/marketers to refine strategies improving the business cycle.

By generating promising products based on the data included in the search data and displaying product lists based on the promising products, the system transforms the search data into relevant product information and generates and displays product listings that are more relevant to the needs of the consumer over known search engines and that increase the likelihood of a consumer purchasing a product displayed in the list, thus increasing the overall revenue being generated by the website/app. The system tests product insights on users, learns from user actions on promising products and vets out suboptimal products, improving search relevance in the aggregate. Users in testing epochs help the system improve and do better for everyone else. For example, the system provides relevant and promising product listings without requiring the consumers to input filter queries and/or product categories, thus reducing the effort required by the consumer to retrieve the desired products from the website.

With reference to the FIGS. and in operation, the present invention provides a system 10, method and computer product media that facilitates an enhanced online product search through retail business process awareness when scoring products on a website/app.

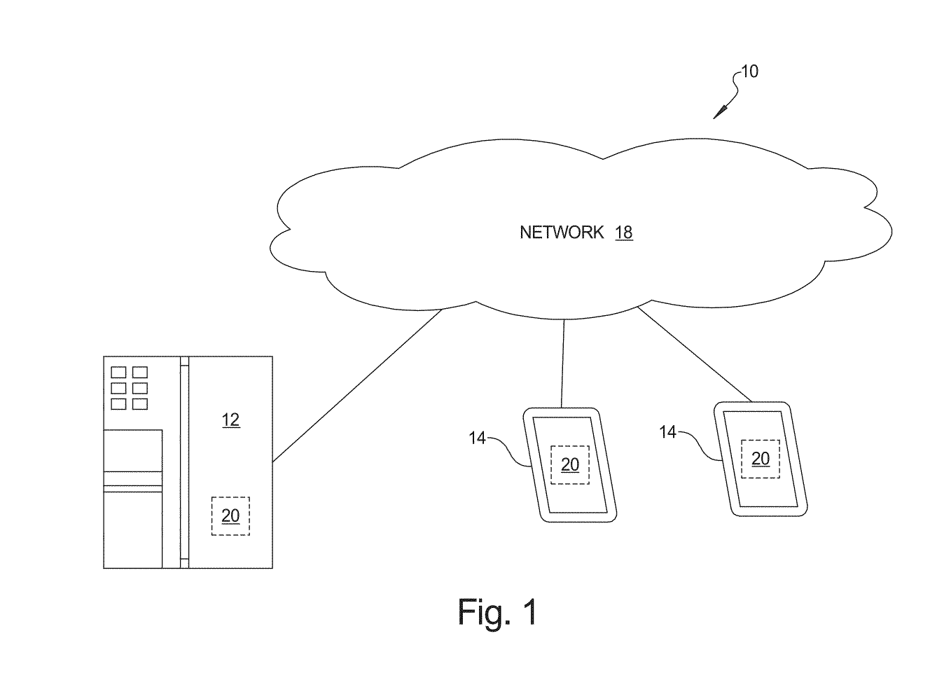

Referring to FIG. 1, an exemplary environment in which the system 10, according to the present invention, operates is illustrated. The system 10 in which methods described hereinbelow may be implemented. The system 10 may include a server system 12 that may be embodied as one or more server computers each including one or more processors that are in data communication with one another. The server system 12 may be in data communication with one or more user devices 14. In the methods disclosed herein, the user devices 14 are advantageously mobile devices such as a mobile phone or tablet computer. In some embodiments, some or all of the methods disclosed herein may be performed using a user device 14 such as a desktop computer or any other computing device as the user device 14. For purposes of this disclosure, discussion of communication with a user or entity or activity performed by the user or entity may be interpreted as communication with a user device 14 associated with the user or entity or activity taking place on a computer associated with the user or entity. In some embodiments, separate computers of the server system 12 may handle communication with the user devices 14.

Some or all of the server 12 and user devices 14 may communicate with one another by means of a network 18. The network 18 may be embodied as a peer-to-peer wireless connection between devices, a connection through a local area network (LAN), WiFi network, the Internet, or any other communication medium or system.

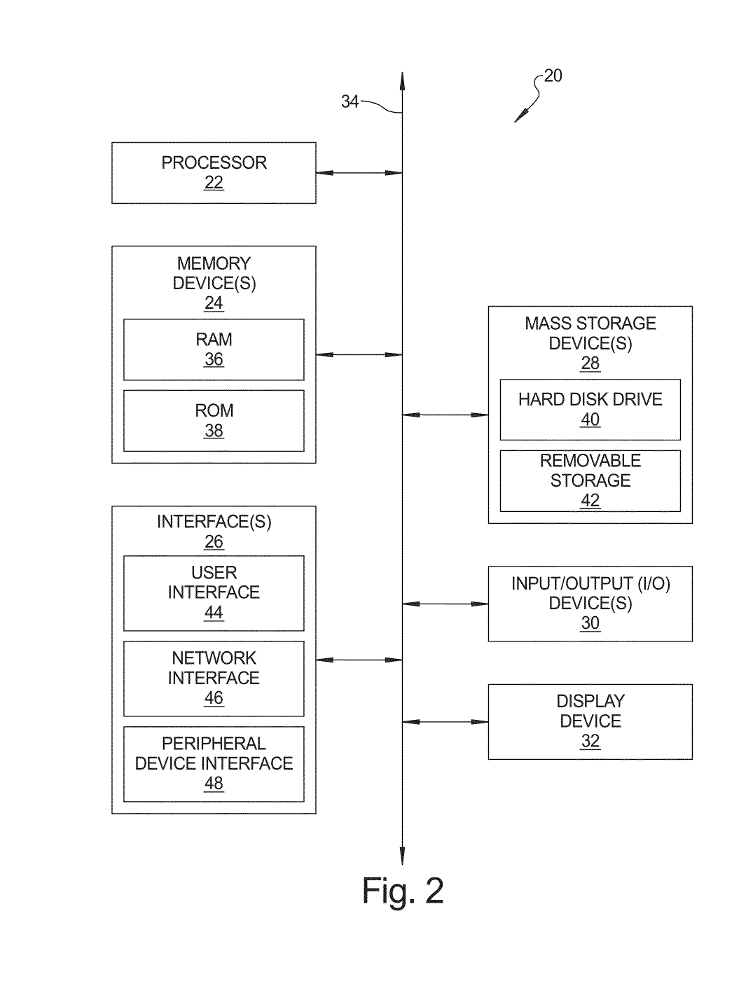

Referring to FIG. 2, an example computing device 20 for the system 10 and user device 14 is shown. The computing device 20 may be used to perform various procedures, such as those discussed herein. The computing device 20 can function as a server, a user, or any other computing entity. The computing device 20 can perform various monitoring functions as discussed herein, and can execute one or more application programs, such as the application programs described herein. The computing device 20 can be any of a wide variety of computing devices, such as a desktop computer, a notebook computer, a server computer, a handheld computer, tablet computer and the like.

The computing device 20 includes one or more processor(s) 22, one or more memory device(s) 24, one or more interface(s) 26, one or more mass storage device(s) 28, one or more Input/Output (I/O) device(s) 30, and one or more display device(s) 32, all of which are coupled to one or more bus(es) 34. The processor(s) 22 include one or more processors or controllers that execute instructions stored in memory device(s) 24 and/or mass storage device(s) 28. The processor(s) 22 may also include various types of computer-readable media, such as cache memory.

The memory device(s) 24 include various computer-readable media, such as volatile memory (e.g., random access memory (RAM) 36) and/or nonvolatile memory (e.g., read-only memory (ROM) 38). The memory device(s) 24 may also include rewritable ROM, such as Flash memory.

The mass storage device(s) 28 include various computer readable media, such as magnetic tapes, magnetic disks, optical disks, solid-state memory (e.g., Flash memory), and so forth. As illustrated in FIG. 2, a particular mass storage device is a hard disk drive 40. Various drives may also be included in mass storage device(s) 28 to enable reading from and/or writing to the various computer readable media. The mass storage device(s) 28 include removable media 42 and/or non-removable media.

The I/O device(s) 30 include various devices that allow data and/or other information to be input to or retrieved from the computing device 20. Example I/O device(s) 30 include cursor control devices, keyboards, keypads, microphones, monitors or other display devices, speakers, printers, network interface cards, modems, lenses, CCDs or other image capture devices, and the like.

The display device(s) 32 include any type of device capable of displaying information to one or more users of the computing device 20. Examples of the display device 32 include a monitor, display terminal, video projection device, display, graphical user interface (GUI), and the like.

The interface(s) 26 include various interfaces that allow the computing device 20 to interact with other systems, devices, or computing environments. The interface(s) 26 may include one or more user interface 44 such as GUIs. The interface(s) 26 may include one or more network interfaces 46. Example interface(s) 26 may include any number of different network interfaces 46, such as interfaces to local area networks (LANs), wide area networks (WANs), wireless networks, and the Internet. The interface(s) 26 may also include one or more peripheral device interfaces 48 such as interfaces for printers, pointing devices (mice, track pad, etc.), keyboards, and the like.

The bus(es) 34 allow the processor(s) 22, memory device(s) 24, interface(s) 26, mass storage device(s) 28, I/O device(s) 30, and display(s) 32 to communicate with one another, as well as other devices or components coupled to the bus 34. The bus 34 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of the computing device 20, and are executed by the processor(s) 22. In some embodiments, the systems and procedures described herein can be implemented in hardware, or a combination of hardware, software, and/or firmware. For example, one or more application specific integrated circuits (ASICs) can be programmed to carry out one or more of the systems and procedures described herein.

For clarity in discussing the various functions of the system 10, multiple computers and/or servers are discussed as performing different functions. These different computers (or servers) may, however, be implemented in multiple different ways such as modules within a single computer, as nodes of a computer system, etc. . . . The functions as performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

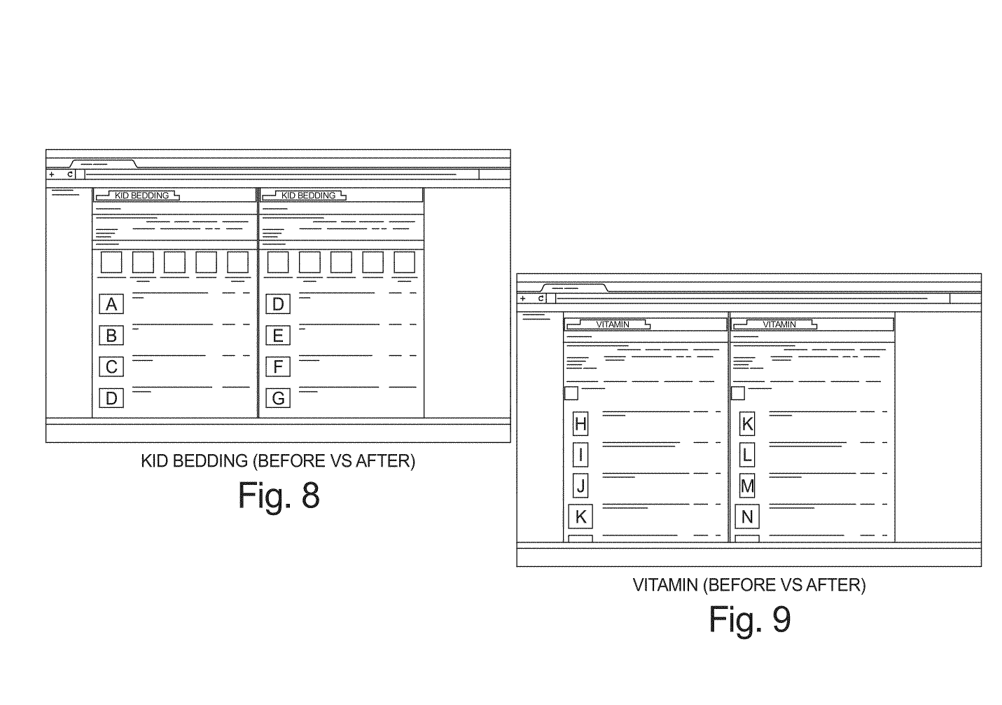

The server 12 is configured to host a website that is accessible by a user via one or more user computing devices 20 or user devices 14. The server 12 retrieves and stores web pages (shown in FIGS. 8 and 9) associated with the website in response to requests received by the user via the user computing device 20 or user device 14 to allow users to interact with the website and search and/or purchase products such as, for example, goods and/or services via the website. In one embodiment, the server is configured to generate and display web pages associated with the website in response to requests being received from consumers via corresponding web browsers that are displayed on the user devices 14. For example, in one embodiment, the server 12 may display a product search webpage (shown in FIGS. 8 and 9) in response to receiving a user request that allows a user to input a product search request including search criteria including one or more search terms. In addition, the server 12 may transmit the product search request to a search engine server and/or a sorting server for use in generating search data in response to the user's search request. The server 12 may also receive one or more product lists from the search engine server and/or the sorting server that includes information associated with products that are selected based on the user's search criteria. The server 12 may also display a search results webpage (shown in FIGS. 8 and 9) to display the product lists to the user and to allow the user to select one or more of the displayed products for purchase.

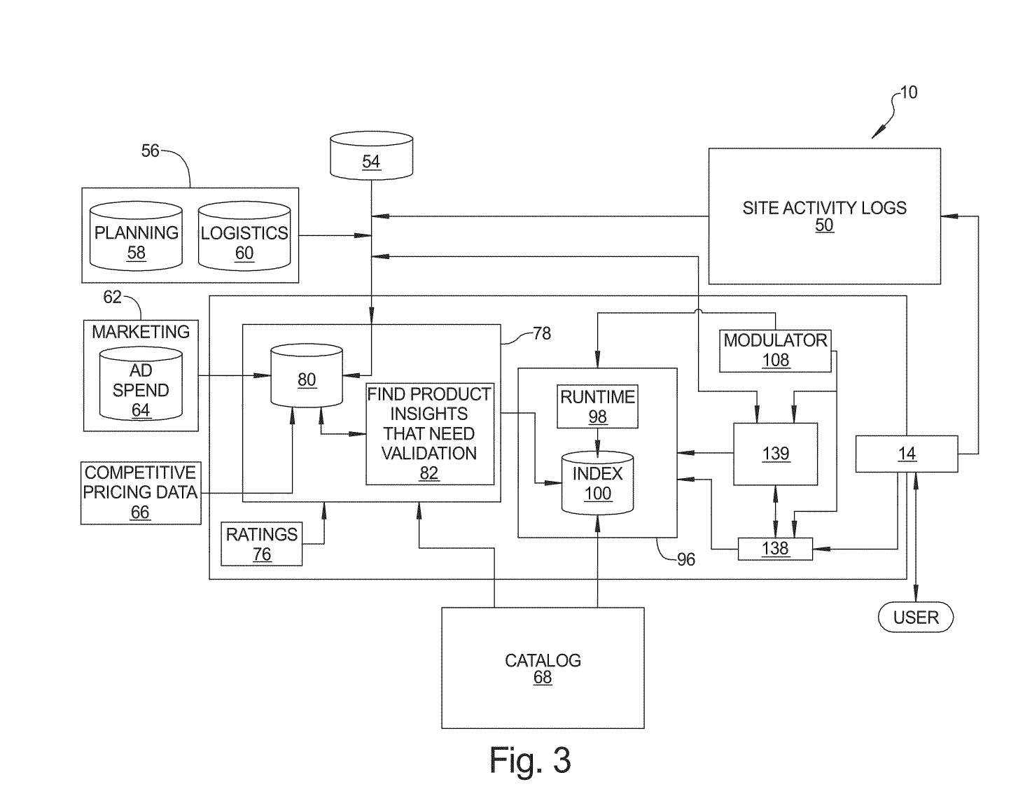

Referring to FIGS. 3 through 6, one embodiment of the system 10 is shown for enhancing online product searches through retail business process awareness and improving the business cycle by generating feedback on validating retailer/planner/marketer actions in e-commerce. In one embodiment, the system 10 includes a database 50 having one or more logs of website activity from the user devices 14 of users. The website activity logs may be from Hubble, Likeshare, Bazaarvoice, Omniture, etc. For example, the website activity logs record search queries, products viewed, etc. The system 10 also includes a database 54 for an order management system (OMS) for products and a database for an inventory management system (IMS) for products. For example, the OMS provides data on how many products are sold daily, weekly, monthly, etc. and the IMS provides data on how many products are stored, products coming in, products going out, etc. The database 64 includes product planning data 58 for products and product logistics data 60 for products. For example, data on how may products are ordered and how many products are in transit. The system 10 includes a database 62 of marketing data for products. For example, the database 62 includes marketing data such as contribution of advertising to the popularity of the product. The database 62 includes a database 64 of advertising spending for products. For example, the data may be the cost of advertising for the product, how much money is spent advertising the product, or traffic due to marketing. The system 10 also includes a database 66 of competitive pricing data. For example, the database 66 of competitive data may include data on competing retailers, prices of the same product sold by competing retailers, and/or competing products. The system 10 further includes a database 68 of product catalog data. For example, data on products in the catalog available for sale by the retailer. The database 68 of product catalog data may include taxonomy, products, and features. For example, this data may be products for sale, product assignments into categories, and enriched product features. It should be appreciated that the databases 50, 54, and 68 are known in the art.

The system 10 also includes a ratings module 76 for providing ratings of products by internal consumers. For example, the ratings may be ratings of the products provided by the consumers or ratings of search results by evaluators. The system 10 further includes a product signals or features module 78. For example, the signals module 78 combines product features generated from different sources for use in search ranking. The signals module 78 is configured to receive data from the databases 50, 54, 56, 62, 66, 68, and 76. The signals module 78 includes a product insights module 80 to generate insights of products. For example, an insight of a product may be a hypothesis that for a particular product query, few specific products would get bought frequently. The product insights module 80 receives inputs of marketing data from the database 62 and competitive pricing data from the database 66. The product insights module 80 also receives inputs of planning and logistics data from the inventory management system database 56, user website activity data from the database 50, and product order data from the order management system database 54. The product insights module 80 provides product hints to be described.

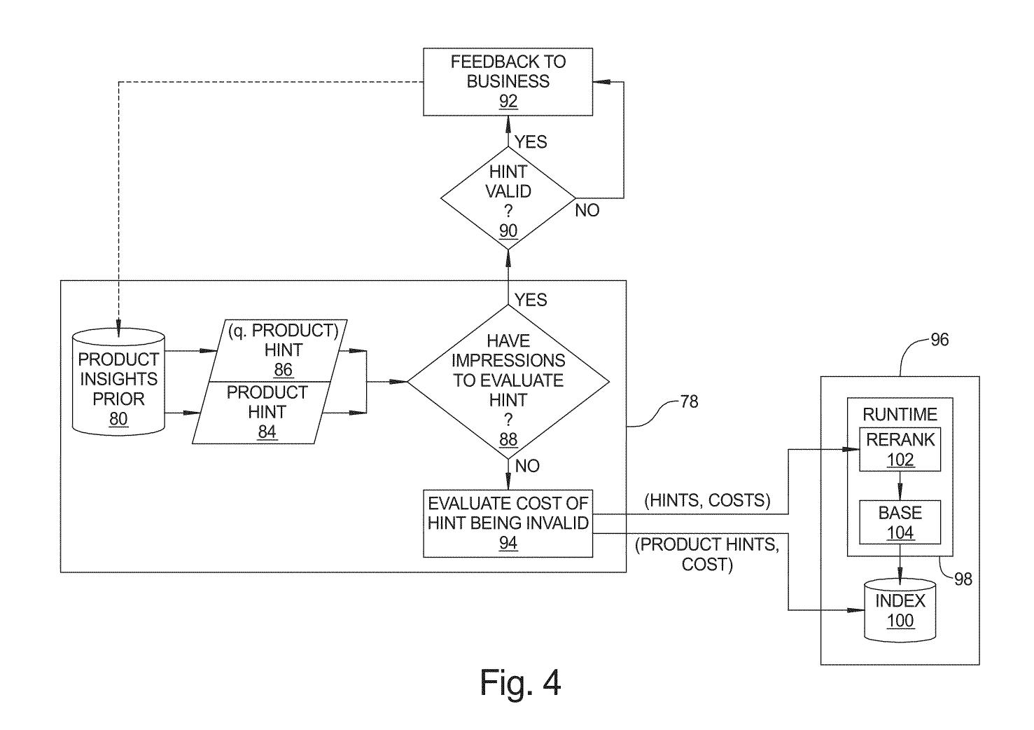

Referring to FIGS. 3 and 4, in the products insights module 80, blocks 84 and 86 produce product hints based on data received by the products insights module 80. For example, a product hint could be that a new product is going to be popular. The products hints in blocks 84 and 86 are hints about products. For example, in block 84, the product hint may be an older version of a movie would sell well because a sequel is due for release or may be torchlights would sell well because there is a blackout. For example, in block 86, the product hint may be a particular product would do well for a particular search query/particular product would do well in general. The signals module 78 also includes a validate/exploit module 82 for finding products or marking product hints that need validation. In the validate/exploit module 82, the validate/exploit module 82 also determines whether there are impressions to evaluate the product hint in block 88. For example, the module 82 receives the product hint from either block 84 and/or 86. If there are impressions to evaluate the product hint, block 90 determines whether the product hint is valid. For example, an impression is where a product is presented or shown to a consumer and an observation is recorded. If the product hint is valid or not valid, block 92 traces the source of hint back to business actions and provides feedback to the merchants/planners/marketers in the business and helps improve the business cycle. For example, this feedback may be in the form of do not plan for high inventory on a product because a lot of consumers have seen the product and have not purchased it. This feedback is also communicated back to the product insights module 80. If there are not impressions to evaluate the product hint, block 94 evaluates the cost of the product hint being valid. For example, the cost of the product hint is determined from data such as the competitive pricing data, advertising data, etc. It should be appreciated that the module 82 validates business information quickly as to what products will do well in online retailing. It should be appreciated that FIG. 4 is a breakdown of hint accumulation and scoring for the product. It also should be appreciated that the output provided to a ranking module 102 is scoring for the product. It should further be appreciated that hint accumulation and scoring allow retailers to bet that a product will do well or not and get consumer feedback before committing and locking up capital on few products.

The system 10 also includes a search engine server or module 96 to perform a product search. In the illustrated embodiment, the search engine module 96 is configured to receive a product search request from the server 12 including one or more search terms, and generate search data including a plurality of product records as a function of the search terms. For example, in one embodiment, the search engine module 96 may initiate a search algorithm based on a Boolean model to search product records contained in the database based on search terms received from the user. The search engine module 96 generates a search data set including product records matching the search criteria, and generates a relevance score associated with each product record included in the search data set. In one embodiment, the relevance score may be determined based on statistical information, including, but not limited to the number of product records in the database, the frequency with which the search terms appear in the database, and the frequency with which the search term appears in the product record. The relevance of a returned search record may be determined based on the corresponding relevance score and the relevance scores of the other product records in the search data set, wherein product records having a higher relevance score are more relevant to the search criteria. For example, in one embodiment, the product records may include a product description including one or more terms associated with the corresponding product. The search engine module 96 may generate a relevance score associated with the product record as a function of the number of terms included in the product description that match the search terms included with the product search request. In addition, the relevance score may be within a range between about 0.01 to 1.0, with a relevance score of 1.0 being indicative of the most relevant product record. Many variations to the above described method of determining a relevance score associated with a search request fall within the scope of the present invention.

In the illustrated embodiment, the search engine module 96 generates the search data in response to the user's product search request and transmits the search data to the sorting server for use in generating products lists being displayed to the user via one or more search results webpage. In one embodiment, the search engine module 96 generates the search data including a plurality of product records. For example, each product record may include a product category value associated with the product category, a price value associated with the price data category, and/or a search relevance score value associated with the relevance score data category.

After the product insights are evaluated and those needing additional testing identified by the module 82, the signals module 78 provides an output of product hints and cost of hint previously described to the search engine module 96. The search engine module 96 includes a search runtime module 98 and a product index module 100 to be described. As illustrated in FIG. 4, the runtime module 98 includes a product rerank module 102 and a product base search module 104 to be described. It should be appreciated that the search engine module 96 performs product searches based on a search query form the user device 14 of the user. It should be appreciated that the product catalog database 68 is an input to the product index module 100.

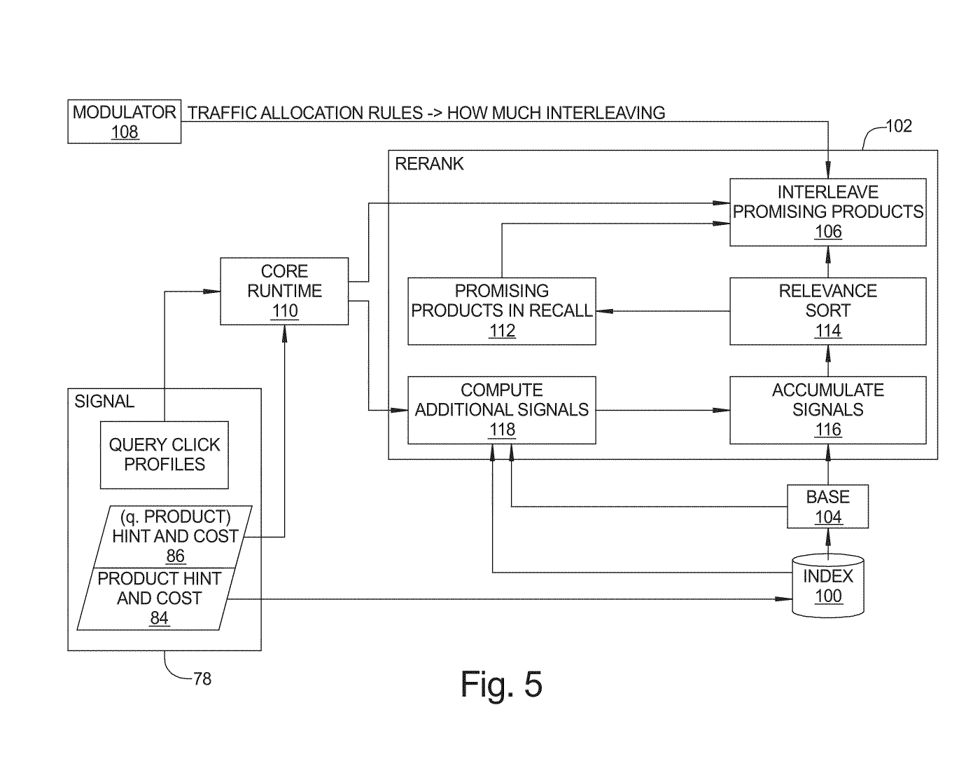

Referring to FIGS. 3 and 5, in the product rerank module 102, block 106 receives an amount of interleaving data of promising products from a modulator 108 of the system 10. For example, promising products are interleaved with ranked products. The modulator 108 specifies traffic allocation rules about how much interleaving of data to perform for a search query, which is provided as an input to block 106. For example, for the search results, promising products that need to get more traffic are sprinkled in with products having a higher ranking. Block 106 also receives a core runtime 110 of the system 10. For example, the core runtime 110 is the time the search is run based on the search query. The core runtime 110 receives inputs of search query click profiles and product hints and costs of blocks 84 and 86 from the module 78 and provides these inputs to the core runtime 110, which in turn, provides this data to the interleaving in block 106.

The product index 100 provides input to the product base search module 104 and compute additional signals block 118 to be described of the rerank module 102. The base search module 104 and additional signals block 118 provide input to an accumulate signals block 116 to be described of the rerank module 102. In the rerank module 102, block 116 provides input to relevance sort block 114 and block 114 sorts the relevance of the promising products based on the inputs of accumulated signals from block 116. Block 114 provides input to block 112 of promising products in recall. Block 114 provides input of the promising products from recall to the interleaving promising products of block 106. For example, block 112 recalls promising products that are ranked higher. It should be appreciated that block 106 interleaves promising products with ranked products. It should also be appreciated that a method and system for reranking search results in a product search engine is disclosed in U.S. Patent Application Publication No. 2014/0297630 to Cao et al., the entire disclosure of which is hereby expressly incorporated by reference.

For example, in one embodiment, the sorting server may generate a ranked list of product values based on a number of times each search query term appears in the product data, and select the sorting value as a function of the ranked list of product values. The sorting server generates a ranked list of product values and determines the product values having the highest frequency of appearance in the search data. The sorting server may select a first sorting value indicative of the product value having the highest appearance frequency, and generate the sorted group including product records having corresponding product values matching the sorting value.

In addition, the sorting server may also select a set of sorting values based on the ranked list of product values, and generate the sorted group including product records having corresponding product values matching at least one sorting value included in the set of sorting values. For example, the sorting server may select one or more product values having high appearance frequencies and generate the sorted group including product records having corresponding product values matching the selected product values. The sorting server may also select the group of sorting values including a predefined number of product values.

In one embodiment, the sorting server may select the sorting value including one or more search relevance score values associated with the relevance score data and generate the sorted group as a function of the selected relevance score values. In one embodiment, the sorting server may generate the sorted group including product records having relevance values that are equal to or greater than the sorting value. In another embodiment, the sorting server may select the sorting value including a range of relevance values and generate the sorted group including product records having corresponding relevance values that are within the selected range of relevance values.

For example, in one embodiment, the product records may include search relevance score values within a range between about 0.01 and 1.0. The sorting server may select the sorting value including a search relevance score value such as, for example, a 0.6 relevance score. The sorting server may then generate the sorting group including the product records having a corresponding search relevance score values that is greater than or equal to the sorting value of 0.6 relevance score.

Referring again to FIGS. 3 and 5, block 116 accumulates signals of the promising products. For example, block 116 accumulates features of promising products such as a new product. Block 118 computes additional signals from the product index 100, base search module 104, and the core runtime 110. For example, the features are computed to pull up products having a higher ranking. It should be appreciated that it is known in the art that computed signals are used for ranking. It should also be appreciated that the module 102 taken as a whole takes a number of products, reorders the order of the products, and returns ordered list. It should further be appreciated that FIG. 5 is a breakdown of the ranking module and the final score is a combination of product popularity, query-product fit, and product hints.

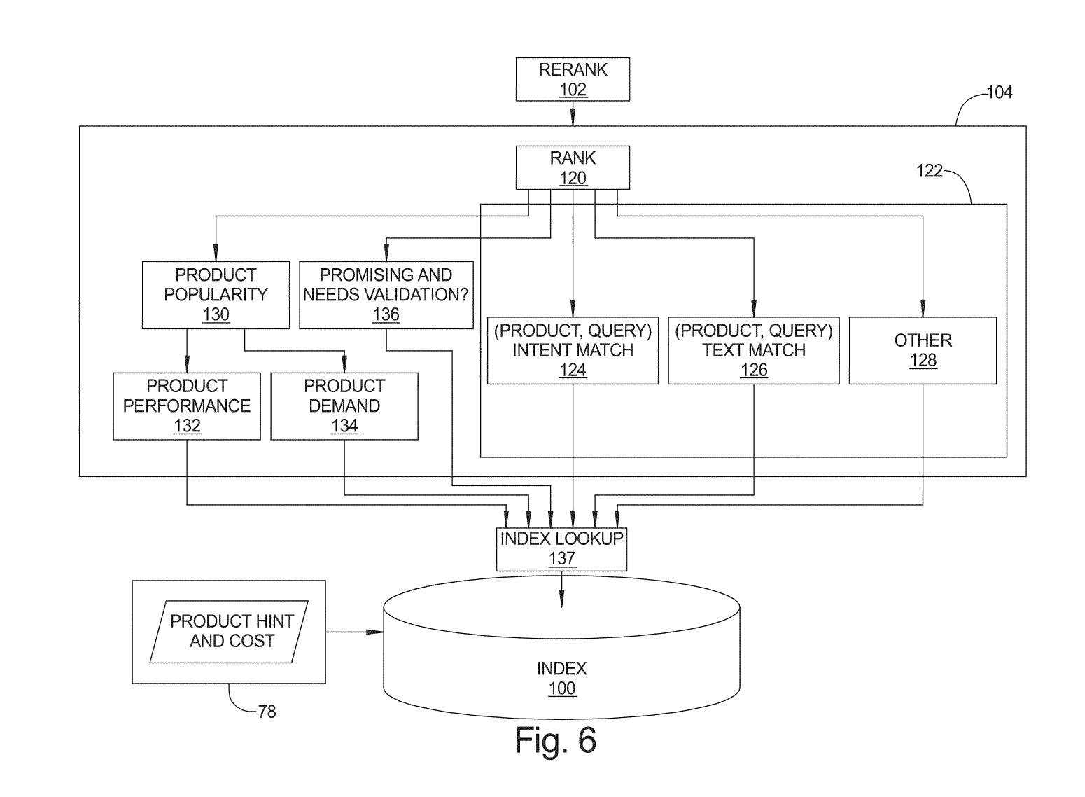

Referring to FIGS. 3 and 6, the base search module 104 receives a rerank of the product from the rerank module 102. In the base search module 104, block 120 determines the rank of the products trading off relevance with testing promising products. For example, block 120 determines that the product has a ranking compared to other products. The base search module 104 also includes a product fit module 122 that receives a rank of the product from block 120. The product fit module 122 determines if the product fits the search query based on a description of the search query and product. In the product fit module 122, block 124 determines a product intent match based on the products and search query of users, block 126 determines text match based on the text of the products and text of the search query of the users, and block 128 determines the product fit based on other factors that tie the product to the search query based on presence of search terms in a title of the product. From the product fit module 122, blocks 124, 126, and 128 provide output to an index look-up 137 that cooperates with the product index 100.

In the base search module 104, block 130 receives the rank of the product from block 120 and determines the popularity of the product. For example, the popularity of the product may be how many times the product has been viewed or purchased. From block 130, block 132 determines the product performance and block 134 determines the product demand. For example, product performance may be how much of the product has been ordered and product demand may be how much the product has been shown to the user. Blocks 132 and 134 provide output to the index look-up 137. In addition, block 136 receives the rank of the product from block 120 and determines whether the rank of the product is promising and needs validation. Block 136 provides output of the product rank to the index look-up 137. It should be appreciated that the product index 100 is a database of product records or documents stored and accessed by the index look-up 137. It should also be appreciated that the index look-up 137 and product index 100 are known in the art.

Referring back to FIG. 3, the system 10 includes a Tier 1 138 and Tier 2 139 of a search application module. The Tier 1 138 may receive input such as the search query from the user device 14 of the user, input from the modulator 108, and/or input from the Tier 2 139. The Tier 1 138 may also provide output to the Tier 2 139, search engine module 96, and/or search results to the user device 14 of the user. It should be appreciated that the search engine module 96 generates a product list (shown in FIGS. 8 and 9) from the product records and transmits the product list to the server 12 for use in displaying the product list to the user device 14 of the user. It should be appreciated that the modulator 108 and Tier 1 138 and Tier 2 139 of the search application module 138 are known in the art.

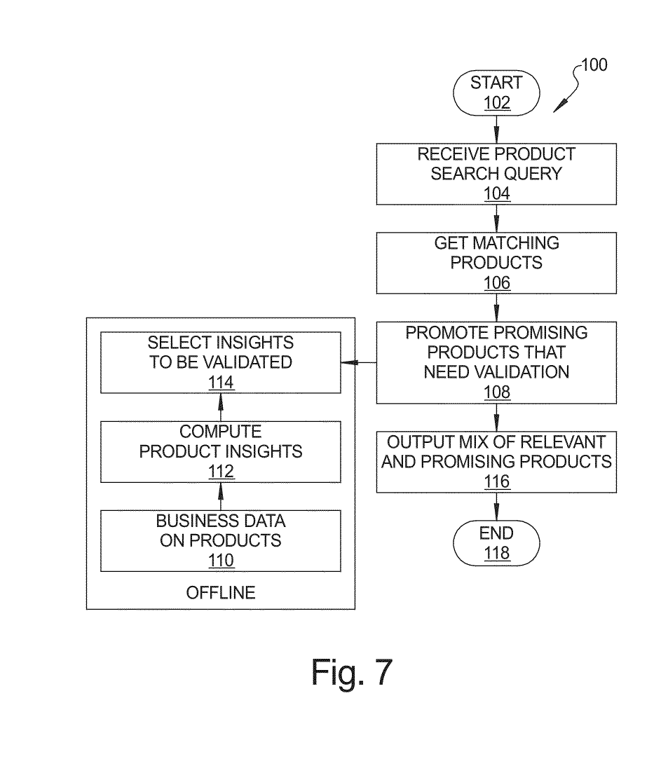

Referring to FIG. 7, a flowchart of a method 100, according to one embodiment of the present invention, used with the system 10 of FIGS. 1 through 6 is shown. The method 100 may be embodied in a products module or server 12 for the system 10. The method 100 starts in block 102. The method includes the steps of receiving a product search query for a product in block 104. For example, receiving a product search query for a product from the user device 14 of the user such as a consumer by the server 12 including the search engine module 96 having a search application. The method includes the step of getting matching products in block 106. For example, getting, by the server 12, products that match the product of the search query from the product index 100. The method 100 further includes the step of promoting promising products that need validation in block 108. This step is performed off-line. For example, ranking, by the server 12, the promising products with a ranking module 102 of the search engine module 96. Off-line, the method 100 also includes the step of receiving one or more inputs of business data in block 110. For example, receiving, by the server 12, one or more inputs of business data on products such as competitive pricing data on products, marketing data on the products, and planning and logistics data on the products as previously described. The method 100 further includes the step of computing product insights on the products based on the business data in block 110. For example, computing, by the server 12, product insights on the products based on the data such as marketing data, competitive pricing data, and planning and logistics data with the products insights module 80. The method 100 also includes the step of selecting product insights to be validated in block 114. For example, validating, by the server 12 with a validate and exploit module, the product insights of the products based on the product insights computed. It should be appreciated that the promising products are promoted based on a reranking with relevant products to the product searched.

After block 108, the method 100 further includes outputting a mix of relevant and promising products as search results to a user device 14 of a user in block 116. For example, outputting, by the server 12, a mix of relevant and promising products based on the interleaving and/or ranking of the products as search results to the user device 14 of the user or consumer for display. The method then ends in block 118.

Referring to FIGS. 8 and 9, the user device 14 can display a product list as the search results to the user such as a consumer. On the display for FIG. 8, an example of a product search query and the search results listed below the search query. For example, a consumer may have queried or searched for a product such as “kid bedding”. The search results on the left show the ranking of the products A, B, C, and D before the present invention. After using the present invention, the search results on the right show a higher ranking for some of the products such as product D and promising products E, F, and G. It should be appreciated that the higher ranking of relevant products results in more sales for the retailer. On the display for FIG. 9, an example of a search query and the search results listed below the search query. For example, a consumer may have queried or searched for a product such as “vitamins”. The search results on the left show the ranking of the products H, I, J, and K before the present invention. After using the present invention, the search results on the right show a higher ranking for some of the products such as product K and promising products L, M, and N. It should be appreciated that the example of FIGS. 8 and 9 is provided for example only and not intended to be limiting.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The present invention has been described in an illustrative manner. It is to be understood that the terminology, which has been used, is intended to be in the nature of words of description rather than of limitation.

What is claimed is:

1. A system comprising:
a computer system including a server configured to receive a product search query;
the server being configured to receive data on products, to compute product insights on the products, to evaluate the product insights, to mark those product insights that need validation, and output the product insights that need validation, to rank the products trading off relevance with testing promising products, and to output a mix of relevant and promising products as search results to a user device of a user.

2. A system as set forth in claim 1, wherein the server is configured to vet out invalid product insights based on user interactions and to trace the invalid product insights back to business actions, thereby providing feedback for improving a business cycle.

3. A system, as set forth in claim 1, wherein the server includes a product insights module and a product hint module configured to receive an input from the product insights module.

4. A system, as set forth in claim 3, wherein the server is configured to receive an input from the product hint module and determine whether there are impressions to evaluate a product hint.

5. A system, as set forth in claim 4, wherein the server determines whether the product hint is valid if there are impressions to evaluate the product hint.

6. A system, as set forth in claim 5, wherein the server determines the cost of the product hint being invalid based on the data and prioritizing product hints with no impressions for validation.

7. A system, as set forth in claim 6, wherein the server includes a rerank module to receive an input of product hints to be evaluated and to output a reranking of the products interleaving relevant and promising products.

8. A system, as set forth in claim 1, wherein said server includes a product index database to receive data of product hints and hint evaluation priorities as an input from the product insights module.

9. A system, as set forth in claim 3, including a rerank module to receive an input from the product insights module, to receive input from a business rule modulator, to receive input from a product index and a base search module, to receive products sorted by relevance from the base search module, and to identify promising products in results from the base search module and moving them to higher positions in a final ranking.

10. A system, as set forth in claim 1, wherein said rerank module includes an interleaving module for mixing relevant and promising products based on business rules for traffic allocation to validation activities.

11. A method comprising the steps of:
receiving a product search query;
receiving data on products;
computing product insights on the products;
evaluating the product insights;
marking those product insights that need validation;
outputting the product insights that need validation;
ranking the products trading off relevance with testing promising products; and
outputting a mix of relevant and promising products as search results to a user device of a user.

12. A method, as set forth in claim 11, including the step of vetting out invalid product insights based on user interactions and tracing the invalid product insights back to business actions, thereby providing feedback for improving a business cycle.

13. A method, as set forth in claim 11, wherein said step of providing a product insights module and providing a product hint module that receives an input from the product insights module.

14. A method, as set forth in claim 13, including the steps of receiving an input from the product hint module and determining whether there are impressions to evaluate a product hint.

15. A method, as set forth in claim 11, including the steps of determining whether the product hint is valid if there are impressions to evaluate the product hint.

16. A method, as set forth in claim 15, including the steps of determining the cost of the product hint being invalid based on the data and prioritizing product hints with no impressions for validation.

17. A method, as set forth in claim 13, including the steps of providing a rerank module and receiving an input of product hints to be evaluated and to output a reranking of the products interleaving relevant and promising products.

18. A method, as set forth in claim 12, including the steps of providing a product index database and receiving data of product hints and hint evaluation priorities as an input from the product insights module.

19. A method, as set forth in claim 11, including the steps of providing a rerank module and receiving an input from a product insights module, receiving input from a business rule modulator, receiving input from a product index and a base search module, receiving products sorted by relevance from the base search module, and identifying promising products in results from the base search module and moving them to higher positions in a final ranking.

20. A method, as set forth in claim 11, including the steps of providing an interleaving module for the rerank module and mixing relevant and promising products based on business rules for traffic allocation to validation activities.

21. One or more non-transitory computer-readable storage media, having computer-executable instructions embodied thereon, wherein when executed by at least one processor, the computer-executable instructions cause the processor to:
receive a product search query;
receive data on products;
compute product insights on the products;
evaluate the product insights;
marking those product insights that need validation;
output the product insights that need validation;
rank the products trading off relevance with testing promising products; and
output a mix of relevant and promising products as search results to a user device of a user.
